(19) United States
(12) Patent Application Publication
(10) Pub. No.: US 2014/0216919 A1
(43) Pub. Date: Aug. 7, 2014

(54) METHOD AND APPARATUS FOR FABRICATING GRAPHENE USING A PLURALITY OF LIGHT SOURCES

(71) Applicants: Seoul National University R&DB Foundation, Seoul (KR); Toshiba Samsung Storage Technology Korea Corporation, Suwon-si (KR)

(72) Inventors: Byung-Youn Song, Suwon-si (KR); Kil-Soo Choi, Seoul (KR); Nag-Eui Choi, Suwon-si (KR); Hyoung-Sub Shim, Seoul (KR); Han-Yung Jung, Seoul (KR); Jung-Hoon Lee, Seoul (KR)

(73) Assignees: Seoul National University R&DB Foundation, Seoul (KR); Toshiba Samsung Storage Technology Korea Corporation, Suwon-si (KR)

(21) Appl. No.: 14/056,373

(22) Filed: Oct. 17, 2013

(30) Foreign Application Priority Data
Feb. 5, 2013 (KR) 10-2013-0013047

(51) Int. Cl. C01B 31/04

(52) U.S. Cl. CPC C01B 31/0446
USPC 204/157.47; 422/164

(57) ABSTRACT

A method of fabricating graphene using a plurality of light sources, and an apparatus for fabricating graphene are provided. The apparatus for fabricating graphene includes a first light source configured to irradiate a graphite oxide layer on a substrate, a second light source configured to further irradiate the irradiated graphite oxide layer, and a control unit configured to control an order of irradiation from the first light source and the second light source.

### CROSS-REFERENCE TO RELATED APPLICATION(S)

This application claims the benefit under 35 U.S.C. §119(a) of Korean Patent Application No. 10-2013-0013047, filed on Feb. 5, 2013, in the Korean Intellectual Property Office, the entire disclosure of which is incorporated herein by reference for all purposes.

### BACKGROUND

1. Field

The following description relates to a graphene fabrication method and an apparatus for fabricating graphene, such as, for example, a graphene fabrication method using a plurality of light sources and an apparatus for fabricating graphene having a plurality of light sources.

2. Description of Related Art

Graphene is an allotrope of carbon, consisting of a single two-dimensional planar sheet of carbon atoms with a thickness of about 0.35 nanometers. In a graphene sheet, carbon atoms are packed into a honeycomb lattice, forming free spaces therebetween. The arrangement of carbon atoms and free spaces therebetween provide a graphene molecule with flexibility that allows a certain degree of deformation. In addition, a hexagonal arrangement of carbon atoms ensures electrical conductivity and chemical stability.

Graphene can carry two hundred times more current than copper and can carry current two hundred times faster than silicon at a room temperature. In addition, graphene has twice the room-temperature thermal conductivity than diamond, and two hundred times more mechanical strength than steel. Therefore, researches for the utilization of graphene, as one of the most promising future electronic materials, have been increasing. Due to such excellent properties, for example, an electrode made of graphene may have both high energy density of a battery and high power performance of a capacitor.

Graphene is generally obtained by an exfoliation method or a synthesis method. In an exfoliation method, a graphene layer may be exfoliated from graphite. Graphite is abundantly present in nature and is easy to obtain. Further, in comparison to a synthesis method, the exfoliation method is characterized by low energy consumption, and enables mass production of graphene. However, with the exfoliation method, it is difficult to achieve graphene molecules having a large surface area, and the yield is low when the amount of graphite consumed is considered. The exfoliation method may be further classified into a physical exfoliation method and a chemical exfoliation method, depending on the treatment method used to achieve the exfoliation.

A synthesis method involves synthesizing a layer of graphene directly from a carbon source. In comparison to the exfoliation method, the synthesis method generally requires more energy. However, the synthesis method enables the production of graphene molecules having a large surface area with low defect ratio.

However, with the above described methods, limitations exist in effectively forming a large amount of graphene having a large surface area and uniformity in molecular structure. For instance, the actual capacitance per unit weight exhibited by the graphene molecules formed by a general method is 99 to 130 F/g, which is much lower than the highest theoretical capacitance value, 550 F/g.

A method of fabricating graphene using a single type of light source, such as laser, has been suggested. However, laser light is concentrated on a relatively small area, and thus it may take a substantial amount of time and energy irradiating a large area with laser light to obtain graphene of a large quantity. Further, the quality of graphene may vary depending on the locations of laser irradiations on a graphite oxide layer.

### SUMMARY

In one general aspect, there is provided an apparatus for fabricating graphene, including: a first light source configured to irradiate a graphite oxide layer on a substrate; a second light source configured to further irradiate the irradiated graphite oxide layer; and a control unit configured to control an order of irradiation from the first light source and the second light source.

The first light source may be configured to produce laser light, and the second light source may be configured to produce flash light.

The control unit may be configured to turn on the first light source to irradiate the graphite oxide layer with laser light, and then to turn on the second light source to irradiate the laser-light-irradiated graphite oxide layer with flash light.

The control unit may be configured to turn on the second light source to irradiate the graphite oxide layer with flash light, and then to turn on the first light source to irradiate the flash-light-irradiated graphite oxide layer with laser light.

The control unit may be configured to turn on the first light source to irradiate the graphite oxide layer with laser light, to turn on the second light source to irradiate the graphite oxide layer with flash light, and to turn on the first light source to irradiate the graphite oxide layer with laser light, in that order.

The control unit may be configured to turn on the second light source to irradiate the graphite oxide layer with flash light, to turn on the first light source to irradiate the graphite oxide layer with laser light, and to turn on the second light source to irradiate the graphite oxide layer with flash light, in that order.

The control unit may be configured to turn on either the first light source or the second light source to irradiate the graphite oxide layer twice consecutively with corresponding light, and then to turn on the other light source to irradiate the irradiated graphite oxide layer once.

The control unit may be configured to turn on either the first light source or the second light source to irradiate the graphite oxide layer once with corresponding light, and to turn on the other light source to irradiate the irradiated graphite oxide layer twice consecutively.

The first light source may be configured to move in X- and Y-axis directions, and the second light source may be configured to move in a Z-axis direction.

The flash light may include Xenon flash or UV flash.

The substrate may be a thermoplastic polymer substrate comprising polycarbonate.

In another general aspect, there is provided an apparatus for fabricating graphene, the apparatus including: a rotating unit configured to rotate a substrate; a first light source configured to expose an upper surface of the substrate to laser light; a second light source configured to expose the upper surface of the substrate to flash light; and a control unit configured to control the first light source and the second light source.

The control unit may be configured to expose the upper surface of the substrate to laser light while the rotating unit rotates the substrate and the first light source moves in a radial direction of the substrate.

The control unit may be configured to expose the upper surface of the substrate exposed to the laser light to flash light from the second light source.

The control unit may be configured to convert a graphite oxide layer placed on the upper surface of the substrate to graphene.

In another general aspect, there is provided a method of fabricating graphene, involving: obtaining a graphite oxide layer on a substrate; and exposing the graphite oxide layer with light from a first light source and light from a second light source, in which the exposing of the graphite oxide layer with light from the first light source involves moving the first light source above the graphite oxide layer, or moving the graphite oxide layer and the substrate under the first light source.

The exposing of the graphite oxide layer with light from the second light source may involve exposing the graphite oxide layer to flash light from the second light source.

The exposing of the graphite oxide layer may involve exposing the graphite oxide layer to the light from the first light source, and then exposing the graphite oxide layer to the light from the second light source.

The exposing of the graphite oxide layer may involve exposing the graphite oxide layer to the light from the second light source, and then exposing the graphite oxide layer to the light from the first light source.

Other features and aspects may be apparent from the following detailed description, the drawings, and the claims.

### BRIEF DESCRIPTION OF THE DRAWINGS

FIG. 1 is a flowchart illustrating an example of a method of fabricating graphene.

FIGS. 2A to 2I are flowcharts illustrating additional examples of methods of fabricating graphene.

FIG. 3 is a diagram illustrating an example of an apparatus for fabricating graphene.

FIG. 4 is a diagram illustrating an example of an apparatus for fabricating graphene having a first light irradiation unit.

FIG. 5 is a diagram illustrating an example of an apparatus for fabricating graphene having a second light irradiation unit.

FIGS. 6A and 6B are diagrams illustrating examples of an apparatus for fabricating graphene, including a first light irradiation unit and a second light irradiation unit, according to another general aspect.

FIG. 7 is a graph illustrating power density and energy density of graphene produced by methods for fabricating graphene described in the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

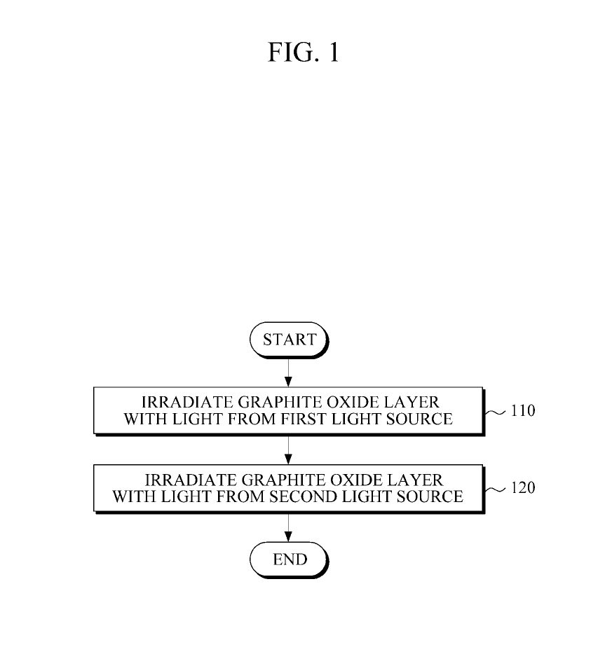

FIG. 1 is a flowchart illustrating an example of a method of fabricating graphene.

The method includes irradiating a thin film layer of graphite oxide applied on a polycarbonate surface of an optical disk, such as a DVD, CD, and the like, with laser light and flash light in turn, at least one time, in order to gradually reduce graphite oxide in the graphite oxide layer to graphene.

Polycarbonate, as a member of a particular thermoplastic polymer group, is capable of being easily manipulated, injection-molded and thermoformed. Polycarbonate is multifunctional engineering plastic with excellent heat-resistance, impact resistance, and optical properties, thereby being widely used for product plastic and engineering plastic and also as a material for exteriors of information appliances, such as, mobile phones, notebook computers, and monitors, and optical storage media, such as CD and DVD.

Although polycarbonate is taken as an example of a substrate material, the substrate may be made of various types of materials, such as resins, ferrous metals and non-ferrous metals.

Referring to FIG. 1, in 110, light from a first light source is used to irradiate a thin film of a graphite oxide layer applied on a surface of the substrate. Then, light from a second light source is used to further irradiate the irradiated graphite oxide layer in order to reduce the graphite oxide in 120.

In this example, the first light source may be a laser light source and the second light source may be a flash light source, or vice versa. For example, the laser light source may emit light of wavelengths used in an optical recording device and/or an optical reproducing device. For example, a general laser light source radiates infrared laser light having a wavelength 780 nm. The wavelength of laser light used in this example may be between 400 nm and 820 nm, but the range of wavelength of the laser light source is not limited thereto.

Flash light radiated from the flash light source momentarily releases energy greater than a predetermined amount. A flash light source that is generally used in a camera is a light source that emits strong light energy over a large area for a short period of time. In this example, various types of flash light sources, such as xenon flash, UV flash, and the like, may be used.

For example, to generate xenon flash light, xenon is injected into a hermetically sealed tube made of quartz glass, which is maintained within a pressure of 1 to 10 percent of atmospheric pressure. Then, a high voltage is applied between both electrodes of the tube, whereby a discharge occurs and a gas is ionized. After a certain period of time, currents of thousands of amperes from a charged condenser pass through the tube while exciting xenon atoms, resulting in the generation of flash light. Xenon flash light is white light having electromagnetic waves of all wavelengths. In an application that requires the use of electromagnetic waves having wavelengths in the infrared range, a different gas, such as krypton, may be used.

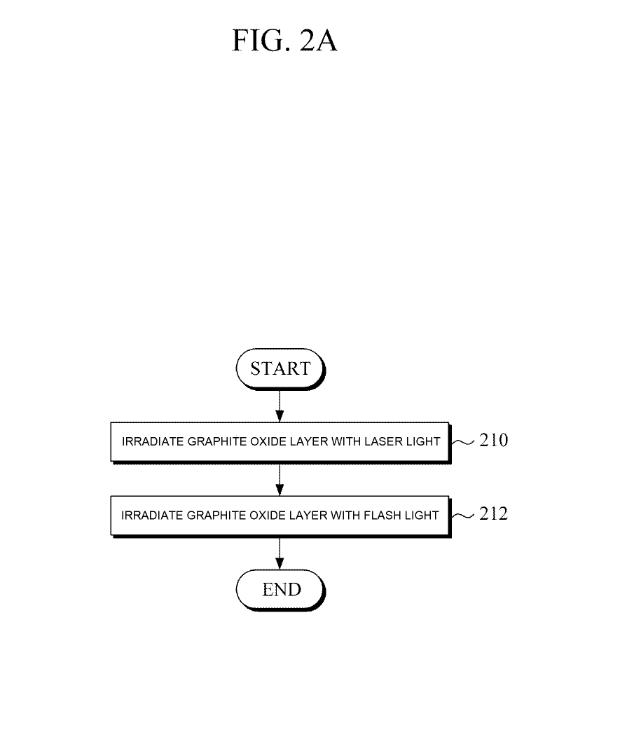

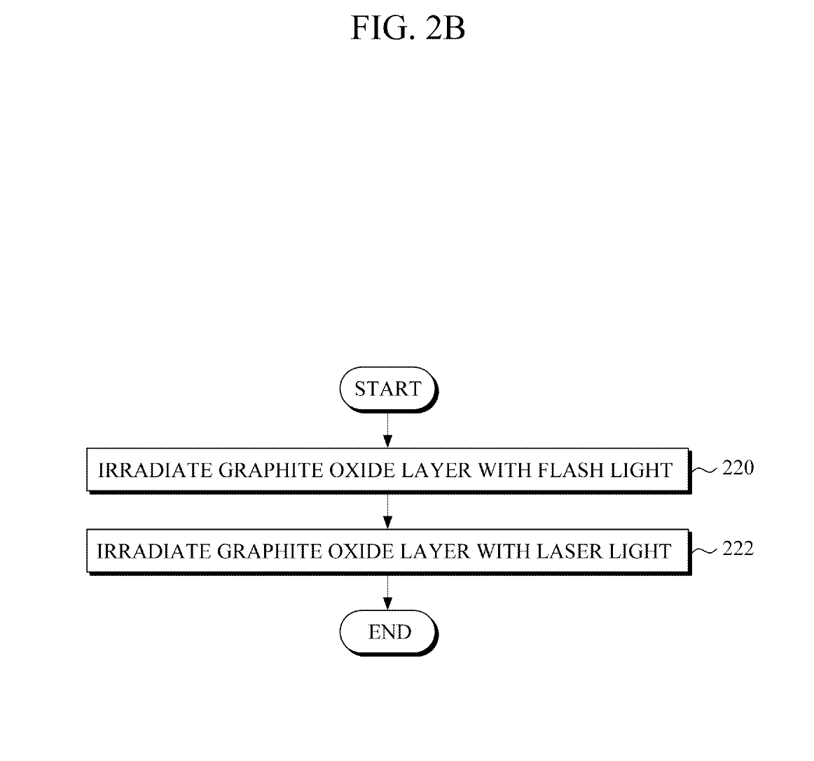

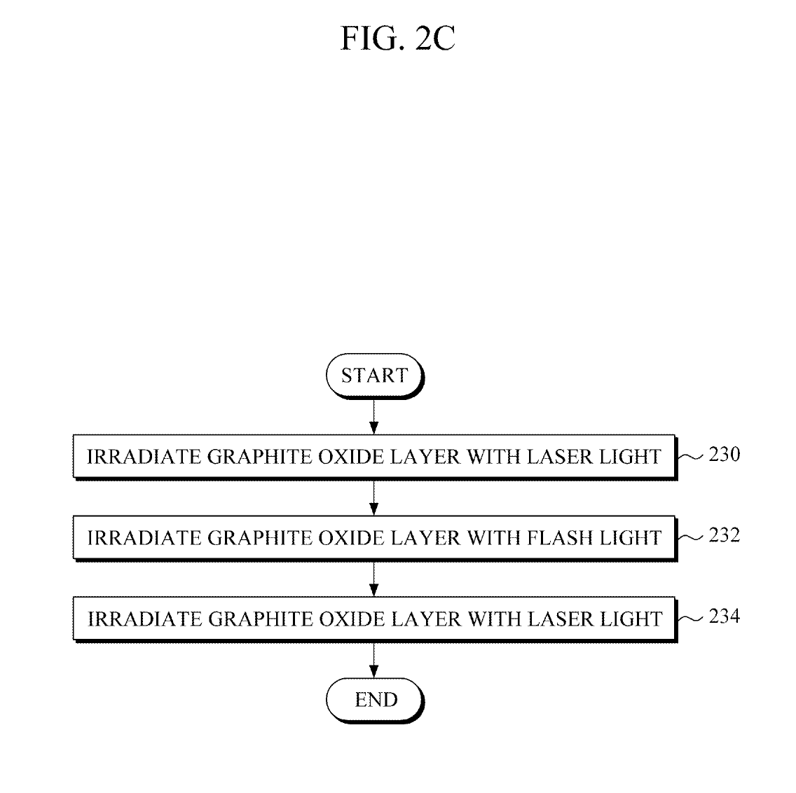

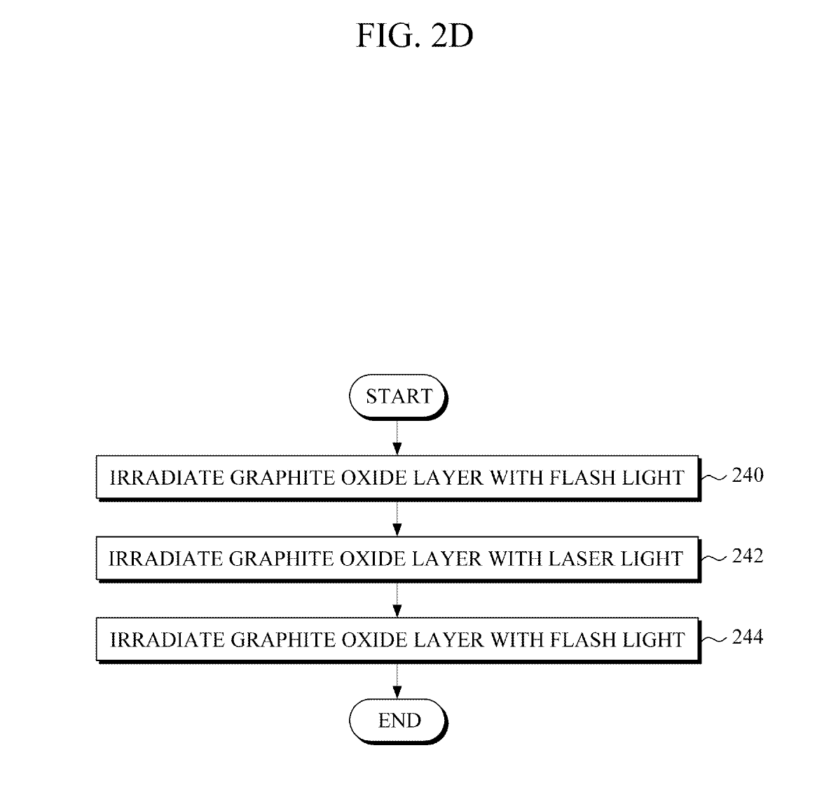

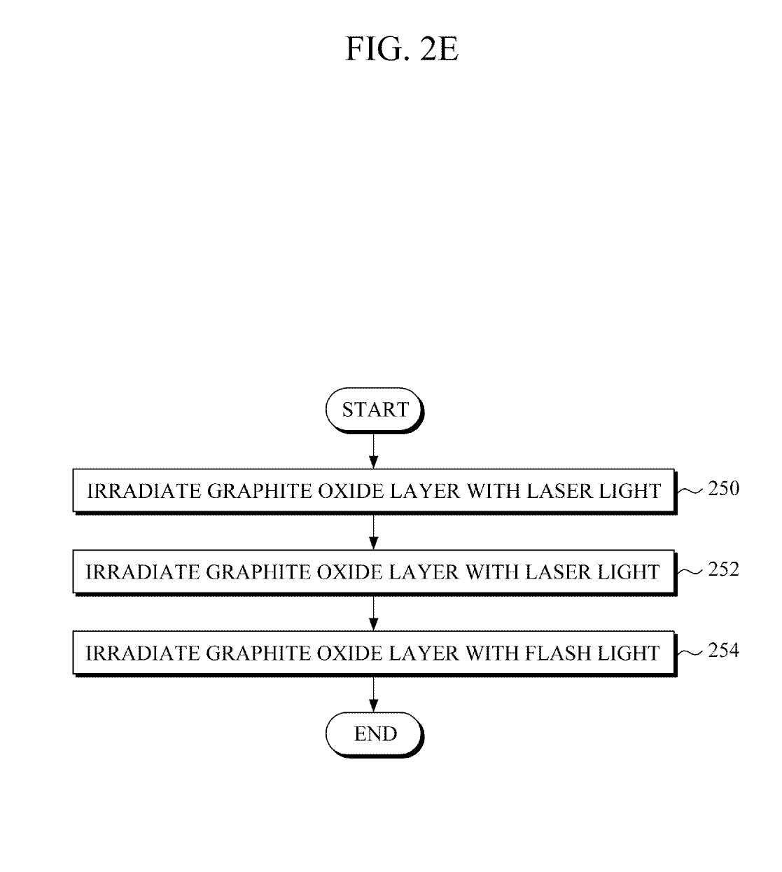

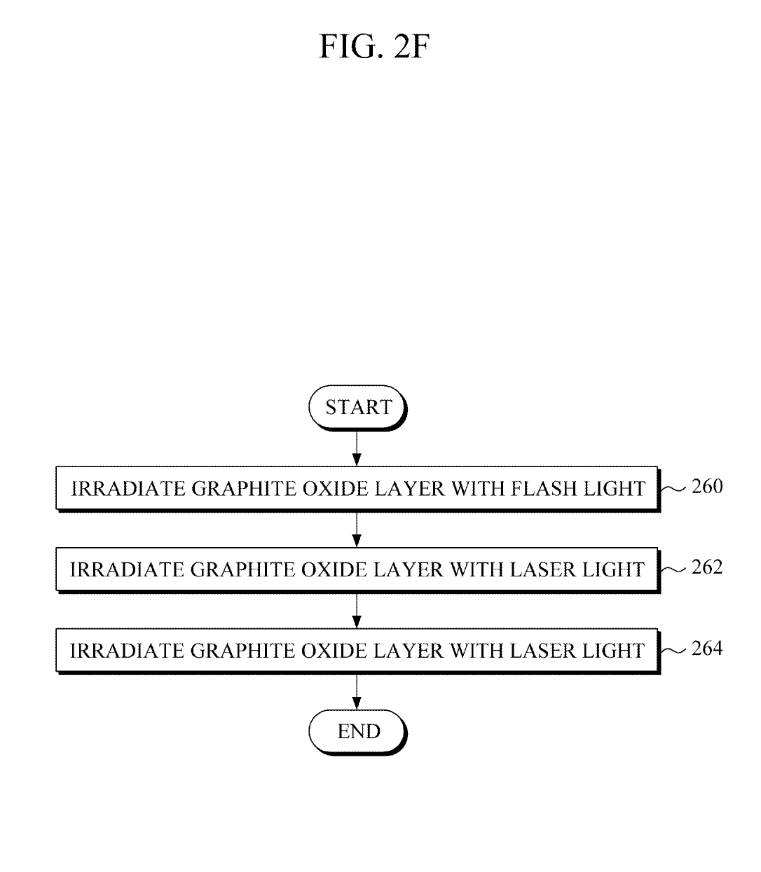

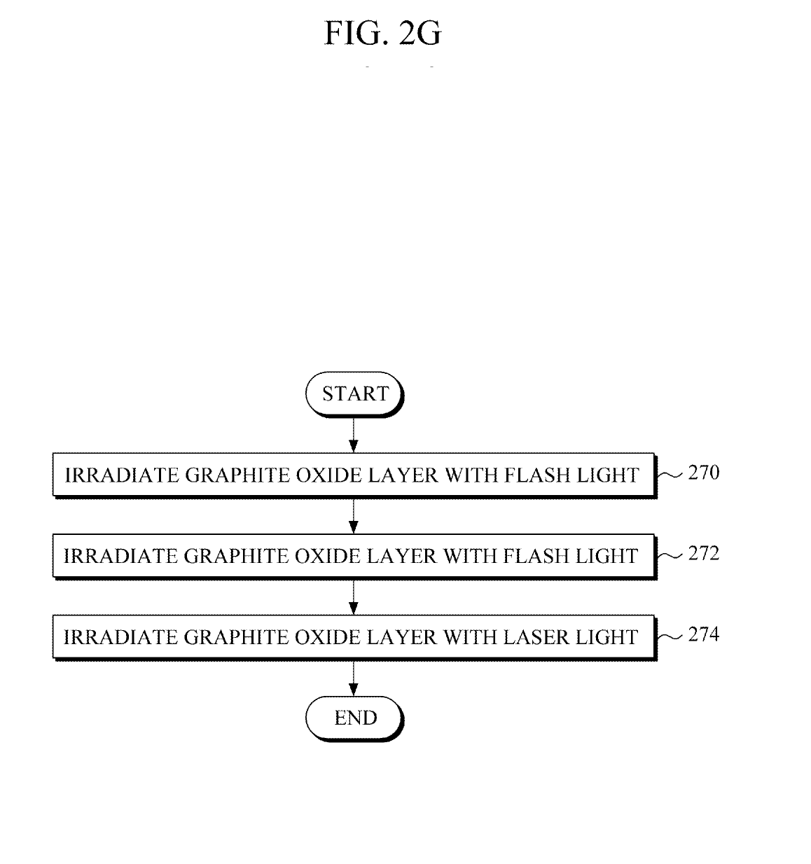

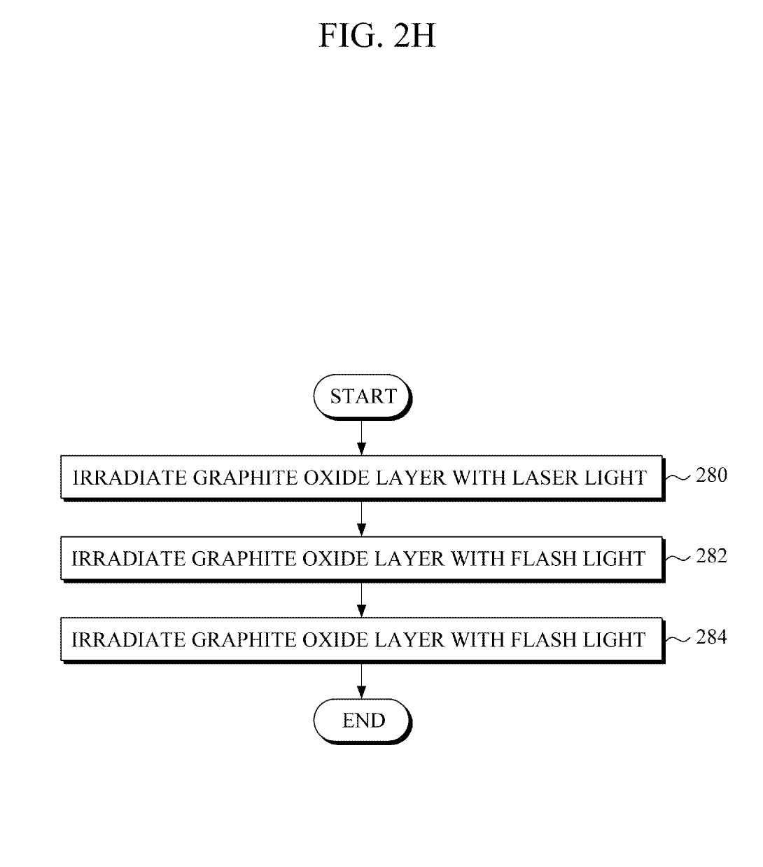

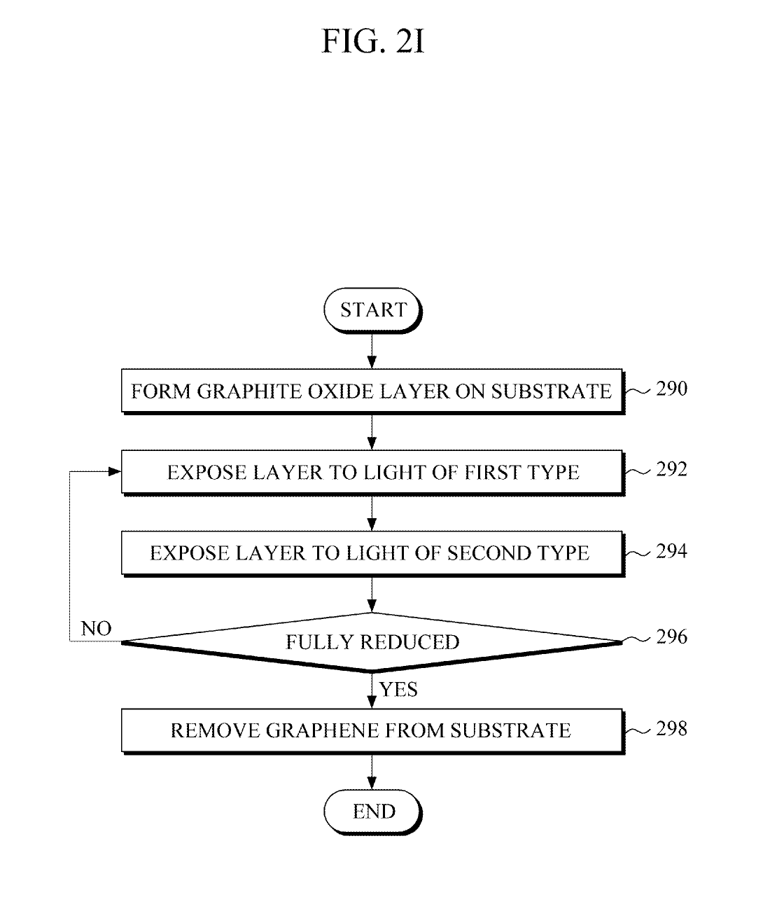

FIGS. 2A to 2I are flowcharts illustrating examples of modifications to the method of fabricating graphene illustrated in FIG. 1.

According to the example illustrated in FIG. 2A, a thin film of a graphite oxide layer applied on a substrate is irradiated by light from a laser light source, thereby being primarily reduced in 210. Then, in 212, the primarily reduced graphite oxide layer is irradiated by flash light from a flash light source, thereby being secondarily reduced. The secondarily reduced graphite oxide layer includes graphene, which is the final product of graphite oxide after full reduction. It is understood that the graphite oxide layer being irradiated may include an intermediate reduction product of graphite oxide while the irradiation operations are being performed.

In another example, the order of performing operations of FIG. 2A may be switched as shown in FIG. 2B. In this example illustrated in FIG. 2B, a thin film of graphite oxide applied on a substrate is irradiated by exposure to flash light from a flash light source in 220, thereby being primarily reduced. Then, in 222, a fully reduced graphite oxide layer is obtained by irradiating the primarily reduced graphite oxide layer with laser light from a laser light source.

In additional examples illustrated in FIGS. 2C to 2H, the secondarily reduced graphite oxide layer may be further irradiated by exposure to light, thereby enhancing the purity of the obtained graphene and increasing the surface area of the graphite oxide layer that is reduced to obtain graphene. As illustrated, many modifications can be made to the method of irradiating laser light and flash light in an alternating manner.

Referring to FIG. 2C, a thin film of graphite oxide applied on a substrate is primarily reduced by irradiating it with light from a laser source in 230. The primarily reduced graphite oxide layer is secondarily reduced by irradiating it with light from a flash light source in 232. Thereafter, final graphene is obtained by irradiating light from the laser light source to the secondarily reduced graphite oxide layer in 234.

The order of performing operations illustrated in FIG. 2C may be switched. For example, as shown in FIG. 2D, the thin film of a graphite oxide applied on the substrate may be primarily reduced by irradiating it with light from the flash light source in 240. Then, the primarily reduced graphite oxide layer may be secondarily reduced by irradiating it with light from the laser light source in 242. Thereafter, graphene is finally obtained by irradiating the secondarily reduced graphite oxide layer with light from the flash light source, in 244.

Also, unlike the examples shown in FIGS. 2C and 2D, the same type of light, either flash light or laser light, may be used to irradiate the graphite oxide layer consecutively for two or more times.

For example, as shown in FIG. 2E, after a graphite oxide layer is irradiated with laser light in 250, the graphite oxide layer may be further irradiated by the laser light in 252, and then by flash light in 254. In addition, as shown in FIG. 2F, the order of the irradiation operations may be changed, wherein the flash light is first irradiated on the graphite oxide layer in 260 and then laser light is used to irradiate the reduced graphite oxide layer successively in 262 and 264.

In the example illustrated in FIG. 2G, a graphite oxide layer is successively irradiated twice by the flash light in 270 and 272. Thereafter, the graphite oxide layer is further irradiated with laser light in 274. Alternatively, as shown in FIG. 2H, a graphite oxide layer may be first irradiated with laser light in 280, and then irradiated successively with flash light for two times in 282 and 284.

In the example illustrated in FIG. 2I, a graphite oxide layer is formed on a substrate in 290. The substrate may be a polycarbonate substrate of an optical disk. In the alternative, the substrate may be a plate having a dimension similar to an optical disk. For example, the plate may be a thermoplastic polymer substrate having a diameter or width greater than 6 cm and less than 30 cm, or greater than 11 cm and less than 13 cm. In the alternative, the substrate may have a greater or smaller diameter, or have a rectangular or polygonal shape. These sizes and shapes of the thermoplastic polymer substrate are provided only as an example, and are not limited thereto. The graphite oxide layer may include graphite oxide powder or flakes.

The graphite oxide layer may be exposed to light of first type and light of second type in an alternating manner in 320 and 330. However, exposure to light of one type may be repeated for twice or more before the layer is exposed to light of the other type. In this example, the is light of first type and the light of second type may be laser light and flash light.

Also, three or more light sources that produce different wavelengths may be used to irradiate the graphite oxide layer. The exposure to alternating types of light may be repeated until the graphite oxide in the graphite oxide is fully reduced to graphene. In 350, the fully reduced graphene is collected or gathered from the surface of the substrate. When graphene is collected, it is possible that some portions of the graphite oxide layer may still include graphite oxide that has not been fully reduced.

In the examples shown in FIGS. 2A to 2I, the flash light or the laser light is irradiated two or three times. However, the number of irradiation is not limited thereto and the light irradiation by the same light source may be repeated more than three times in a given method.

Laser light is radiation that results from simultaneous emission of a large quantity of photons, and generally irradiates only a small area which is however strongly affected by the direct laser irradiation. For example, the area irradiated by infrared laser light is about 1 μm in diameter. Accordingly, it is difficult and inefficient to irradiate the entire area of a graphite oxide layer with the laser light. To overcome such difficulties, flash light irradiation is also carried out to provide optical energy simultaneously to a large area. Accordingly, a remaining area of the layer, other than the area that is directly irradiated with laser light and most strongly reduced, is also reduced with flash light. Thus, a specific surface area where reduction occurs is increased, resulting in a high capacitance. The laser light irradiation and the flash light irradiation may be performed in a complementary manner.

An explosion may occur on the surface of the graphite oxide layer when the simultaneous reduction of a large area by the flash light takes place. Such an explosion results in the graphite oxide layer having a porous structure. As the layer has more pores, the specific surface layer increases, and thus the layer can accumulate more electric charges, resulting in a higher capacitance, compared with the case of fabricating a capacitor.

In one example, the reduced graphene may be collected in a form of a compressed layer of graphene. The graphite oxide layer that is exposed to laser light tends to be reduced as graphene in a form of a compressed layer. Exposure to flash light tends to result in a powder form of graphene. Performing a laser light irradiation before a flash light reduction may secure the structure of the graphite oxide layer, so that the laser light-irradiated graphite oxide layer is prevented from being scattered during a flash light irradiation process. Accordingly, in one example, the graphite oxide layer is first exposed to laser light before being exposed to flash light. However, the method of reducing the graphite oxide layer applied on the substrate is not limited thereto.

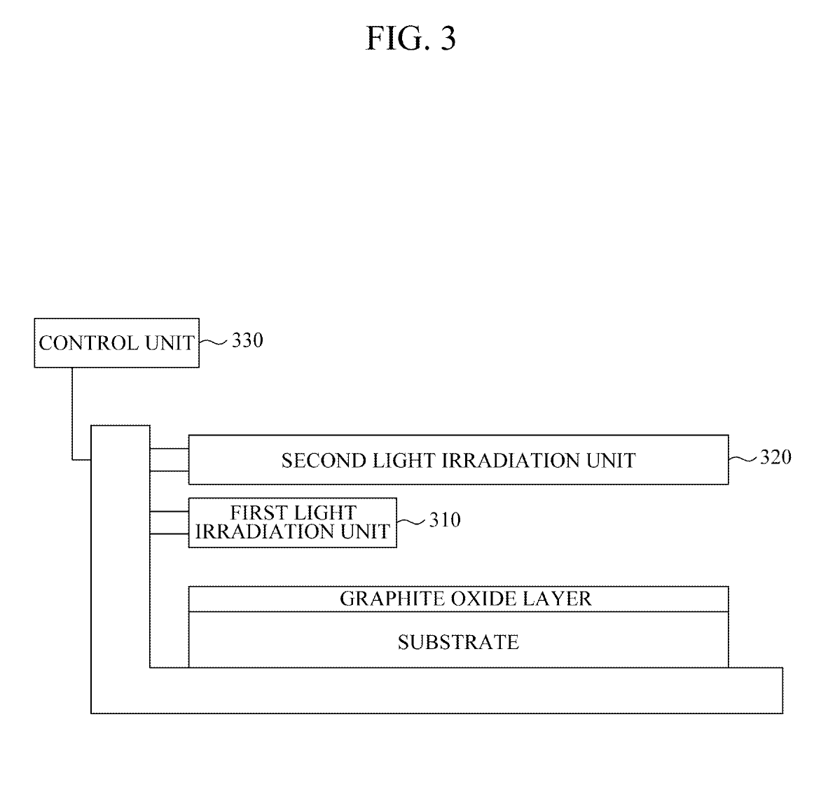

FIG. 3 is a diagram illustrating an example of an apparatus for fabricating graphene. Referring to FIG. 3, the apparatus may include a first light irradiation unit 310, a second light irradiation unit 320, and a control unit 330. The first light irradiation unit 310 includes a first light source and irradiates a graphite oxide layer applied on a substrate with light emitted from the first light source. The graphite oxide layer may be a thin film of graphite oxide provided on a substrate. The second light irradiation unit 320 includes a second light source and irradiates the graphite oxide layer that has been irradiated with light from the first light irradiation unit 310. For example, the first light source may be a laser light source, and the second light source may be a flash light source. In addition, since the irradiation area of the first light source is relatively small due to the fact that the first light source is a laser light source, the first light source may be configured to move over the graphite oxide layer to irradiate the graphite oxide layer sufficiently with the laser light. For example, the first light irradiation unit 310 may be configured to move in X- and Y-axis directions, and optionally in a Z-axis direction, as well. Here, the X-axis and the Y-axis refers to an X-axis and a Y-axis of the same plane as the substrate with the graphite oxide layer applied thereon, and the Z-axis indicates a direction perpendicular to the plane.

The second light irradiation unit 320 may include a light source, such as flash, being capable of irradiating a relatively larger area of the graphite oxide layer with flash light. Thus, the second light irradiation unit 320 does not need to move along an X-axis and/or Y-axis direction(s), but may include a moving unit to move along a Z-axis direction to adjust a direction from the flash light source to the graphite oxide layer so as to control the intensity of the irradiated light.

The laser light source may emit laser light of wavelengths used in an optical recording device and/or an optical reproducing device, and the flash light source may emit light with energy greater than a predetermined amount, including xenon flash and UV flash, as described above.

The control unit 330 may control the order of irradiation of the first light irradiation unit 310 and the second light irradiation unit 320, so as to reduce the graphite oxide layer to graphene in a stepwise manner. For example, the control unit 330 may control the first and the second light irradiation units 310 and 320 such that the first light source is turned on to irradiate the graphite oxide layer with laser light and then the second light source is turned on to further irradiate the laser-light-irradiated graphite oxide layer with flash light. Alternatively, the control unit 330 may control the first and the second light irradiation units 310 and 320 such that the second light source is first turned on to irradiate the graphite oxide layer with flash light and then the first light source is turned on to irradiate the resulting graphite oxide layer with laser light.

In another example, the control unit 330 may irradiate the graphite oxide layer with the same light more than twice. For example, the control unit 330 may control the first and the second light irradiation units 310 and 320 such that the first light source is turned on to irradiate the graphite oxide layer with laser light, then the second light source is turned on to irradiate the graphite oxide layer with flash light and again the first light source is turned on to irradiate the laser light. Alternatively, by changing the order of irradiations, the control unit 330 may control the first and the second light irradiation units 310 and 320 such that the second light source is first turned on to irradiate the graphite oxide layer with flash light, the first light source is then turned on to irradiate the flash-light-irradiated graphite oxide layer with laser light, and again the second light source is turned on to irradiate the flash light.

In yet another example, the control unit 330 may control the first and second light irradiation units 310 and 320 such that either the first light source or the second light source is first turned on to irradiate the graphite oxide layer with the corresponding light once, and thereafter the other light source is turned on to irradiate the graphite oxide layer with the second corresponding light twice, consecutively.

The control unit 330 may be positioned next to the graphite oxide layer or positioned away from the graphite oxide layer, provided the control unit 330 is configured to control the movement of the first and second light irradiation units 310 and 320.

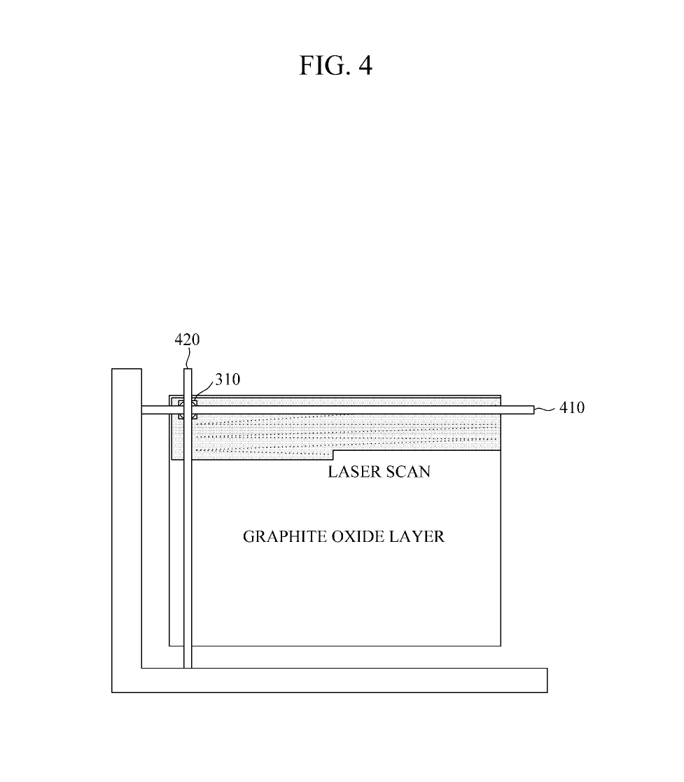

FIG. 4 is a diagram illustrating an example of an apparatus with a first light irradiation unit 310.

FIG. 4 is a top view of the apparatus of FIG. 3. For convenience of explanation, the second light irradiation unit 320 is not shown. As shown in FIG. 4, the irradiation area of a laser beam is very small. Thus, the first light irradiation unit 310 may include an X-axis moving unit 410 and a Y-axis moving unit 420, so as to irradiate the graphite oxide layer sufficiently by moving the laser light along X- and Y-axis directions. The X-axis moving unit 410 and Y-axis moving unit 420 illustrated in FIG. 4 may be implemented with a bracket or a pole, for example. The first light irradiation unit 310 may further include a Z-axis moving unit, but it is optional because a change in energy of laser light depending on the irradiation distance is negligible. In the example illustrated in FIG. 4, the Z-axis moving unit is not shown. However, the Z-axis moving unit may be also implemented with a bracket or a pole.

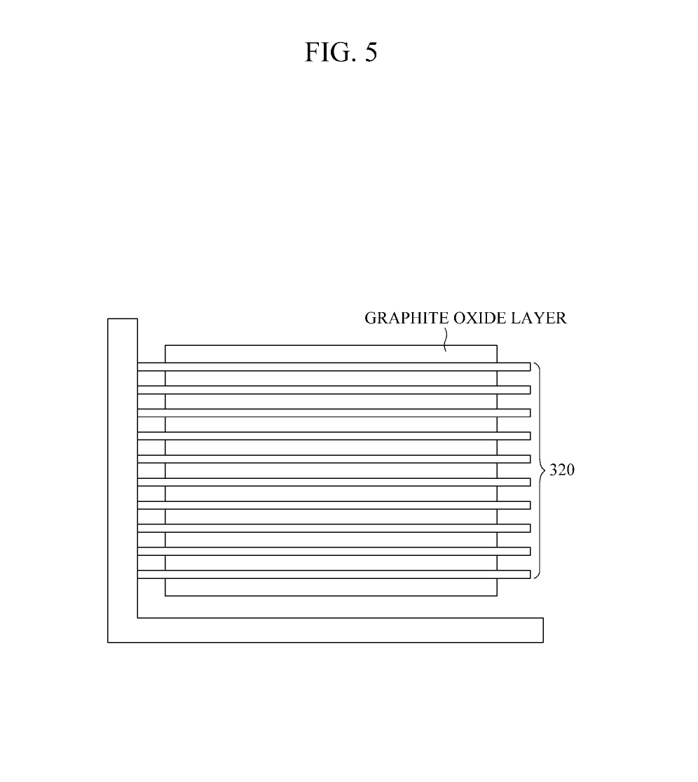

FIG. 5 is a diagram illustrating an example of an apparatus with a second light irradiation unit.

Like FIG. 4, FIG. 5 is a top view of the apparatus of FIG. 3. For convenience of explanation, the first light irradiation unit is not shown. As shown in FIG. 5, the second light irradiation unit 320 may be arranged in an array so that it can evenly irradiate the graphite oxide layer with flash light. Although the second light irradiation unit 320 is arranged in an array along an X-axis in FIG. 5, it may be arranged in an array along a Y-axis direction, or arranged in an X-Y grid. Unlike the laser light, energy of the flash light that reaches its subject is affected by the irradiation distance. Accordingly, in this example, the second light irradiation unit 320 may further include a Z-axis moving unit. However, it is not necessarily required, and the size view of the Z-axis moving unit is not shown in FIG. 5.

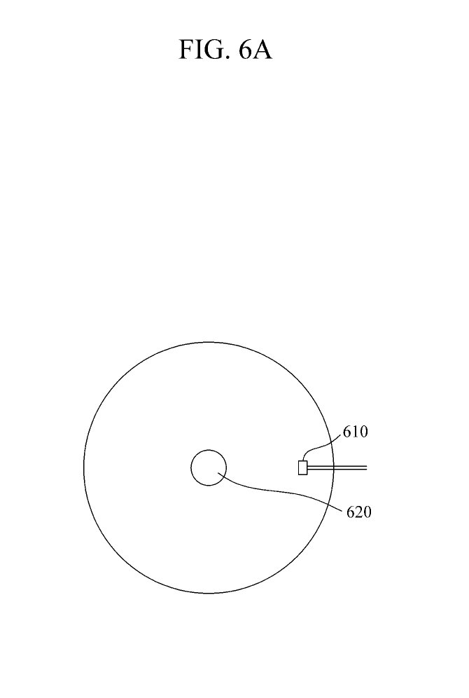

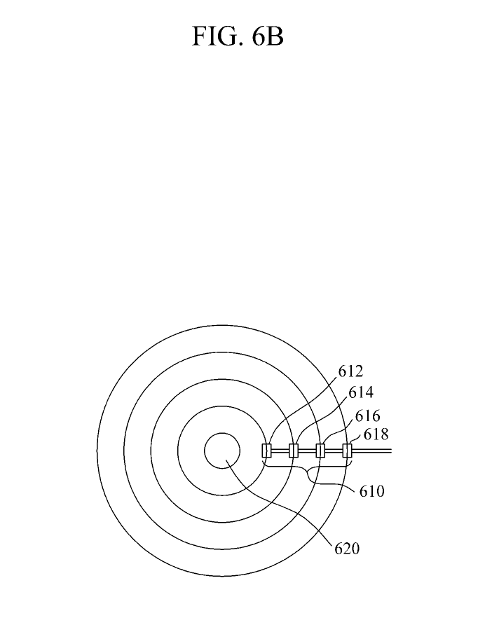

FIGS. 6A and 6B are diagrams illustrating examples of an apparatus for fabricating graphene, including a first light irradiation unit 610 and a second light irradiation unit 620, according to another general aspect.

In this example, a general optical recording/reproducing device may be used to apply a thin film of a graphite oxide layer to an optical disk inside the general optical recording/reproducing device. The general optical recording/reproducing device may be further used to irradiate flash light and laser light to the graphite oxide layer according to the examples described above. In this example, an X-axis moving unit and a Y-axis moving unit are not necessary. Rather, only a circumferential moving unit may be present because the optical disk may be rotated by a rotating unit of the optical recording/reproducing device, as illustrated in FIGS. 6A and 6B.

For example, while the optical disk with the graphite oxide layer applied thereon is being rotated, a first light irradiation unit 610 may be capable of irradiating the entire surface of the graphite oxide layer with laser light while moving in a direction perpendicular to the circumference of the disk. To reduce laser light irradiation time, as shown in FIG. 6B, the first light irradiation unit 610 may include a plurality of light elements 612, 614, 616, and 618, each of which irradiates a portion of the disk with laser light.

In FIGS. 6A and 6B, the optical disk is divided into four portions, and four light elements are provided for each portion. However, the number of portions and light elements are not limited thereto. In addition, the light elements may not be fixed in their positions along the radius of the disk.

A second light irradiation unit 620 including a flash light source may be located at a position corresponding to the center of the optical disk, or at a different position in accordance with the intensity of flash light. A plurality of second light irradiation unit 620 may be also present, depending on the size of the disk and the intensity of flash light.

Further, each of the first light irradiation unit 610 and the second light irradiation unit 620 may include a Z-axis moving unit as described above. However, a Z-axis moving unit may not be necessary in some examples, and are thus omitted from FIGS. 6A and 6B.

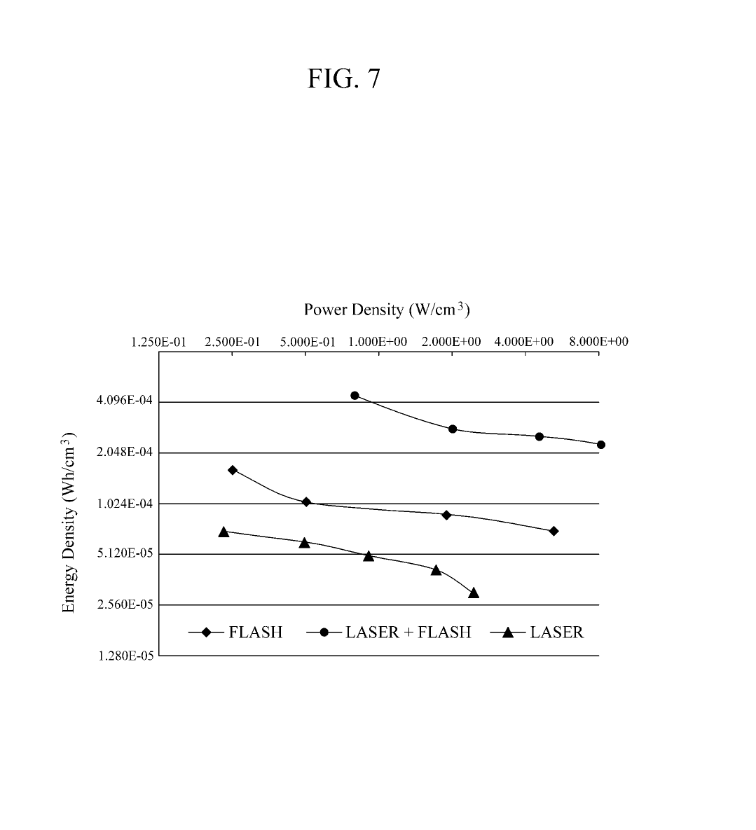

FIG. 7 is a graph illustrating power density and energy density of graphene produced by a method according to the above-described examples.

Referring to FIG. 7, it is noticed that, in comparison with an energy storage element, such as a capacitor, which is made of graphene produced via either laser light or flash light, an energy storage element made of graphene fabricated via both laser light and flash light has higher power density and energy density. In the example taken for FIG. 7, 1.0 M of sulfuric acid aqueous solution is used as an electrolyte.

Both a laser light source and a flash light source are used in the fabrication of graphene to reduce a graphite oxide layer. Accordingly, it is possible to reduce a large area of the graphite oxide layer quickly and more evenly as compared to a method in which only one type of light source is used. Accordingly, with these examples of fabrication methods, graphene can be mass produced in a high quality at a lower cost. In addition, the graphene produced by the methods described above has superior characteristics than graphene produced by other methods, as illustrated in FIG. 7.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for fabricating graphene, comprising:
a first light source configured to irradiate a graphite oxide layer on a substrate;
a second light source configured to further irradiate the irradiated graphite oxide layer; and
a control unit configured to control an order of irradiation from the first light source and the second light source.

2. The apparatus of claim 1, wherein the first light source is configured to produce laser light, and the second light source is configured to produce flash light.

3. The apparatus of claim 2, wherein the control unit is configured to turn on the first light source to irradiate the graphite oxide layer with laser light, and then to turn on the second light source to irradiate the laser-light-irradiated graphite oxide layer with flash light.

4. The apparatus of claim 2, wherein the control unit is configured to turn on the second light source to irradiate the graphite oxide layer with flash light, and then to turn on the first light source to irradiate the flash-light-irradiated graphite oxide layer with laser light.

5. The apparatus of claim 2, wherein the control unit is configured to turn on the first light source to irradiate the graphite oxide layer with laser light, to turn on the second light source to irradiate the graphite oxide layer with flash light, and to turn on the first light source to irradiate the graphite oxide layer with laser light, in that order.

6. The apparatus of claim 2, wherein the control unit is configured to turn on the second light source to irradiate the graphite oxide layer with flash light, to turn on the first light source to irradiate the graphite oxide layer with laser light, and to turn on the second light source to irradiate the graphite oxide layer with flash light, in that order.

7. The apparatus of claim 2, wherein the control unit is configured to turn on either the first light source or the second light source to irradiate the graphite oxide layer twice consecutively with corresponding light, and then to turn on the other light source to irradiate the irradiated graphite oxide layer once.

8. The apparatus of claim 2, wherein the control unit is configured to turn on either the first light source or the second light source to irradiate the graphite oxide layer once with corresponding light, and to turn on the other light source to irradiate the irradiated graphite oxide layer twice consecutively.

9. The apparatus of claim 1, wherein the first light source is configured to move in X- and Y-axis directions, and the second light source is configured to move in a Z-axis direction.

10. The apparatus of claim 2, wherein the flash light includes Xenon flash or UV flash.

11. The apparatus of claim 1, wherein the substrate is a thermoplastic polymer substrate comprising polycarbonate.

12. An apparatus for fabricating graphene, the apparatus comprising:
a rotating unit configured to rotate a substrate;
a first light source configured to expose an upper surface of the substrate to laser light;
a second light source configured to expose the upper surface of the substrate to flash light; and
a control unit configured to control the first light source and the second light source.

13. The apparatus of claim 12, wherein the control unit is configured to expose the upper surface of the substrate to laser light while the rotating unit rotates the substrate and the first light source moves in a radial direction of the substrate.

14. The apparatus of claim 13, wherein the control unit is configured to expose the upper surface of the substrate exposed to the laser light to flash light from the second light source.

15. The apparatus of claim 12, wherein the control unit is configured to convert a graphite oxide layer placed on the upper surface of the substrate to graphene.

16. A method of fabricating graphene, comprising:
obtaining a graphite oxide layer on a substrate; and
exposing the graphite oxide layer with light from a first light source and light from a second light source,
wherein the exposing of the graphite oxide layer with light from the first light source comprises moving the first light source above the graphite oxide layer, or moving the graphite oxide layer and the substrate under the first light source.

17. The method of claim 16, wherein the exposing of the graphite oxide layer with light from the second light source comprises exposing the graphite oxide layer to flash light from the second light source.

18. The method of claim 16, wherein the exposing of the graphite oxide layer comprises exposing the graphite oxide layer to the light from the first light source, and then exposing the graphite oxide layer to the light from the second light source.

19. The method of claim 16, wherein the exposing of the graphite oxide layer comprises exposing the graphite oxide layer to the light from the second light source, and then exposing the graphite oxide layer to the light from the first light source.
